(19) United States
(12) Patent Application Publication
(10) Pub. No.: US 2008/0272130 A1
(43) Pub. Date: Nov. 6, 2008

(54) Conformable High-Pressure Gas Storage Vessel And Associated Methods

(76) Inventor: Tarek Saleh Abdel-Baset, Windsor (CA)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/743,688

(22) Filed: May 3, 2007

(51) Int. Cl. F17C 1/02

(52) U.S. Cl. 220/586; 429/13

(57) ABSTRACT

The technology described herein provides hydrogen storage and delivery systems, including both on-board and off board systems. Additionally, the technology provides a conformable high-pressure hydrogen storage vessel that utilizes porous hollow microspheres to store and release hydrogen. This technology still further provides a net endothermic (upon gas desorption) material inserted into and encapsulated within the porous hollow microspheres to store hydrogen, and a heat exchange system to release the stored hydrogen out of the microspheres.

### FIELD OF THE INVENTION

The technology described herein relates generally to storage and delivery systems for hydrogen or other low molecular weight gases, including both on-board and off-board systems. More specifically, this technology relates to an on-board storage technology for hydrogen-powered vehicles. This technology further relates to a conformable high-pressure hydrogen storage vessel that utilizes porous hollow microspheres to store and release hydrogen. This technology still further relates to a net endothermic (upon gas desorption) material inserted into and encapsulated within the porous hollow microspheres to store hydrogen or another gas, and a heat exchange system to release the stored hydrogen, from the microspheres.

### BACKGROUND OF THE INVENTION

Hydrogen is quickly becoming an acceptable alternative to petroleum-based fuels in automotive vehicles. However, a deficiency in its utilization, especially in on-board uses such as in hydrogen-powered vehicles, has been the lack of an acceptable storage vessel. Hydrogen storage tanks known in the art are generally cylindrical in shape, regardless of the industry or the gas stored inside. Hydrogen storage tanks known in the art require thick walls to retain high pressures, thus consuming space, increasing material costs, and precluding the option of designing a conformable storage tank. For example, hydrogen storage tanks known in the art include carbon fiber tanks. Carbon fiber tanks generally include prohibitively expensive materials. Additionally, the manufacturing time associated with carbon fiber tanks is excessive. Therefore, carbon fiber tanks are unsuitable for cost-effective, high-volume productions. Other approaches to creating, semi-conformable tanks generally utilize a series of smaller joined carbon tanks. This approach to hydrogen storage is complex, time-consuming, and expensive. Additionally, a storage tank to be used in an automotive vehicle must be manufactured in a suitable size such that it fits properly within the vehicle. Thus, there are tradeoffs between tank wall thickness, to adequately and safely store and release hydrogen, and the space available within a vehicle to locate the hydrogen storage tank. It is a desire of automotive manufacturers to design a pressurized hydrogen storage container that has a conformable shape. Thus, what is needed in the art is a high-pressure hydrogen storage vessel that is conformable, much like most, conventional automotive gasoline storage tanks, utilizing remaining, unused space that is left over after the design process.

Also known in the art is a design of Hydrostatic Pressure Retainment™ (HPR™) tanks for fuel cell vehicles. This technology is disclosed in Design of Hydrostatic Pressure Retainment Tanks for Fuel Cell Vehicles, by Bhavin V. Mehta and Robert J, Setlock, Jr. (SAE technical Paper 2004-01-1012), HPR allows for designing and manufacturing pressure vessels in any size and shape and from any homogenous isotropic material. HPR is based on the principle that the smaller the diameter of a sphere, the thinner the wall thickness of that sphere is in order to safely contain a certain pressure. Based on this principle, HPR utilizes thousands of foam bubbles together with a flow path connecting them all to produce a storage tank that holds hydrogen at very high pressures without the need for thick cylindrical walls to support the pressure. The foam itself is referred to as an “inner support matrix” that collectively contains the high pressure. In manufacture, the foam is expanded into a desired mold to create a vessel. The void pockets in the foam are hydrogen storage areas. The foam material thus serves as the pressure walls.

Unfortunately, foaming technology is hardly accurate in creating bubbles of uniform shape and size throughout the entire storage vessel. A deviation from the uniform shape weakens the sphere and requires a thicker wall to contain the pressure. Also, a larger sphere requires a thicker wall. There is obviously a high probability in foaming technology that there will be certain regions in the inner support matrix in which a bubble is too large and/or deformed and thus has a thin wall thickness. In such cases, that bubble section will burst from the application of high pressure. Once a bubble bursts and spills into adjacent bubbles, a larger, more deformed bubble is created, likely setting off a chain reaction that continues until every bubble in the storage vessel has burst, rendering the storage vessel useless. Thus, what is still needed in the art is a conformable high-pressure storage vessel utilizing spherical shapes without utilizing the deficient foaming technologies.

### BRIEF SUMMARY OF THE INVENTION

In various exemplary embodiments, the technology disclosed herein provides a conformable high-pressure hydrogen storage vessel that utilizes porous hollow microspheres to store and release hydrogen, or another low molecular weight gas. This technology is for use in both on-board and off-board systems. Other comparable uses are also contemplated herein, as will be obvious to those of ordinary skill in the art.

In one exemplary embodiment, the technology provides a hydrogen storage system for storing hydrogen under pressure. The system includes a conformable high-pressure hydrogen storage vessel and a plurality of microspheres, the microspheres being generally uniform in diameter and size, generally porous, and hollow, and the plurality of microspheres being disposed within the conformable high-pressure hydrogen storage vessel to facilitate the high-pressure storage and release of hydrogen. The system also includes a liquefied, viscous material. The liquefied, viscous material has a lower melting point than the plurality of microspheres and is mixed with the plurality of microspheres. The mixture of the liquefied, viscous material and the plurality of microspheres is uniformly solidified to form a desired and predetermined shape. Optionally, the liquefied, viscous material is a porous network. Optionally, the liquefied, viscous material is metallic or metal oxide based. Optionally the liquefied, viscous material is an organometallic compound such as an Aerogel. Optionally, the liquefied, viscous material is a zeolite.

The hydrogen storage system also includes a mold. The mold is larger in capacity than the mixture of the porous network and the plurality of microspheres. Optionally, the mold is in the predetermined, desired shape of a vehicle fuel tank. The mixture of the liquefied, viscous material and the plurality of microspheres is poured into the mold. The mixture of the liquefied, viscous material and the plurality of microspheres is uniformly solidified to form a conformable high-pressure hydrogen storage vessel in the shape of a vehicle fuel tank.

The hydrogen storage system also includes a coating. The coating includes a hydrogen-resistant material, resistant to both permeation and embrittlement. The coating has the material characteristics sufficient to bond to the mixture of the liquefied, viscous material and the plurality of microspheres once it has uniformly solidified. Additionally, the system includes ancillary equipment, such as, for example, valves, vents, and pressure relief devices.

In another exemplary embodiment, the technology provides a hydrogen storage system that includes a net endothermic (upon gas desorption) material. The net endothermic (upon gas desorption) material is resistant to hydrogen permeation and embrittlement. The net endothermic (upon gas desorption) material is insertable into a hollow portion of one or more individual microspheres of the plurality of microspheres. The net endothermic (upon gas desorption) material is encapsulated within one or more individual microspheres of the plurality of microspheres. Alternatively, for example, the microsphere is formed around the storage material. The overall volumetric hydrogen storage density of the conformable high-pressure hydrogen storage vessel is increased and/or the operating pressure reduced. Optionally, the net endothermic (upon gas desorption) material is a metal hydride. Optionally, the net endothermic (upon gas desorption) material is an adsorbent material.

The hydrogen storage system may also include a heat exchange system. The heat exchange system provides a heat input into the conformable high-pressure hydrogen storage vessel to release hydrogen from the net endothermic (upon gas desorption) material. The heat exchange system further provides cooling to the hydrogen storage system when the hydrogen storage system is being filled with hydrogen. The hydrogen storage system further includes a hydrogen-powered vehicle, the hydrogen powered vehicle having a radiator, and the heat exchange system including the radiator. The hydrogen engine provides the heat input into the conformable high-pressure hydrogen storage vessel to release hydrogen from the net endothermic (upon gas desorption) material and overcome any frictional losses. The system also includes a hydrogen fill line. The hydrogen fill line is located within the conformable high-pressure hydrogen storage vessel, and provides a hydrogen, fill input path to the conformable high-pressure hydrogen storage vessel. Optionally, the system includes a plurality of hydrogen fill lines, providing a plurality of hydrogen fill input paths to the conformable high-pressure hydrogen storage vessel.

In another exemplary embodiment, the system includes a hydrogen-powered vehicle. The hydrogen-powered vehicle is powered by hydrogen stored within an on-board conformable high-pressure hydrogen, storage vessel.

In another exemplary embodiment, the technology provides a hydrogen storage method for storing hydrogen under pressure. The method includes utilizing a plurality of microspheres, the microspheres being generally uniform in diameter and size, generally porous, and hollow; utilizing a liquefied, viscous material, wherein the liquefied, viscous material has a lower melting point than the plurality of microspheres; mixing the plurality of microspheres within the liquefied, viscous material; utilizing a mold, the mold being larger in capacity than the mixture of the liquefied, viscous material and the plurality of microspheres, and the mold being in a predetermined, desired shape; pouring the mixture of the liquefied, viscous material and the plurality of microspheres into the mold; and uniformly cooling the mixture of the liquefied, viscous material and the plurality of microspheres forming a desired and predetermined shape comprising a conformable high-pressure hydrogen storage vessel. Optionally, the net endothermic (upon gas desorption) material is a metal hydride. Optionally, the net endothermic (upon gas desorption) material is an adsorbent material.

The hydrogen storage method also includes utilizing a coating, the coating being comprised of a hydrogen-resistant material, and the coating having a lower melting point than the mixture of the liquefied, viscous material and the plurality of microspheres, and the coating having material characteristics sufficient to bond to the mixture of the liquefied, viscous material and the plurality of microspheres once it has uniformly solidified; and applying the coating to the desired and predetermined shape formed by the uniform cooling of the mixture of the liquefied, viscous material and the plurality of microspheres.

In yet another exemplary embodiment, the technology provides a hydrogen storage method utilizing a net endothermic (upon gas desorption) material, the net endothermic (upon gas desorption) material being resistant to hydrogen permeation, and the net endothermic (upon gas desorption) material being insertable into a hollow portion of one or more individual microspheres of the plurality of microspheres; and inserting the net endothermic (upon gas desorption) material into one or more individual microspheres of the plurality of microspheres. Alternatively, for example, the microsphere is formed around the storage material. The overall volumetric hydrogen storage density of the conformable high-pressure hydrogen storage vessel is increased or operating pressure reduced. The method further includes utilizing a heat exchange system, the heat exchange system providing a heat input into the conformable high-pressure hydrogen storage vessel to release hydrogen from the net endothermic (upon gas desorption) material; utilizing a hydrogen-powered vehicle, the hydrogen powered vehicle having a radiator, and the heat exchange system comprising the radiator; and utilizing one or more hydrogen fill lines, the one or more hydrogen fill lines being disposed about conformable high-pressure hydrogen storage vessel and providing one or more hydrogen fill input paths to the conformable high-pressure hydrogen storage vessel. The hydrogen engine provides the heat input into the conformable high-pressure hydrogen storage vessel to release hydrogen from the net endothermic (upon gas desorption) material. Optionally, the net endothermic (upon gas desorption) material is a metal hydride. Optionally, the net endothermic (upon gas desorption) material is an adsorbent material.

Advantageously, the hydrogen storage system and conformable high-pressure hydrogen storage vessel appreciate a significant manufacturing cost reduction compared to carbon fiber tanks. Additionally, the conformable high-pressure hydrogen storage vessel is made of readily available commodity materials. Furthermore, the manufacturing cycle times are reduced significantly, compatible with many industrial molding processes in other arts. Still furthermore, the hydrogen storage system and conformable high-pressure hydrogen storage vessel overcomes the known deficiencies in foaming technology high pressure storage vessels.

There has thus been outlined, rather broadly, the features of the technology in order that the detailed description that follows may be better understood, and in order that the present contribution to the art may be better appreciated. There are additional features of the technology that will be described and which will form the subject matter of the claims. Additional aspects and advantages of the technology will be apparent from the following detailed description of an exemplary embodiment which is illustrated in the accompanying drawings. The technology is capable of other embodiments and of being practiced and carried out in various ways. Also, it is to be understood that the phraseology and terminology employed are for the purpose of description and should not he regarded as limiting.

### BRIEF DESCRIPTION OF THE DRAWINGS

The technology is illustrated and described herein with reference to the various drawings, in which like reference numbers denote like method steps and/or system components, respectively, and in which:

FIG. 1 is a cross-sectional view of an individual hollow porous microsphere, according to an embodiment of the technology, illustrating, in particular, the porous areas through which hydrogen passes;

FIG. 2 is a cross-sectional view of a conformable high-pressure hydrogen storage vessel, according to an embodiment of the technology, illustrating, in particular, a plurality of microspheres disposed within a porous network mold, and a hydrogen fill line;

FIG. 3 is a cross-sectional view of an individual hollow porous microsphere disposed within a porous network mold of FIG. 2;

FIG. 4 is a cross-sectional view of an individual hollow porous microsphere, according to an alternative embodiment of the technology, illustrating, in particular, the encapsulation of a net endothermic (upon gas desorption) material within the individual hollow porous microsphere; and

FIG. 5 is a cross-sectional view of a conformable high-pressure hydrogen storage vessel, according to an alternative embodiment of the technology, illustrating, in particular, a plurality of microspheres disposed within a porous network mold, a hydrogen fill line, and a heat exchange system.

### DETAILED DESCRIPTION OF THE INVENTION

Before describing the disclosed embodiments of the present invention in detail, it is to be understood that the invention is not limited in its application to the details of the particular arrangement shown here since the invention is capable of other embodiments. Also, the terminology used herein is for the purpose of description and not of limitation.

In various exemplary embodiments, the technology provides a conformable high-pressure hydrogen storage vessel that utilizes porous hollow microspheres to store and release hydrogen or another low molecular weight gas. This technology is for use in both on-board and off-board systems. Other comparable uses are also contemplated herein, as will be obvious to those of ordinary skill in the art.

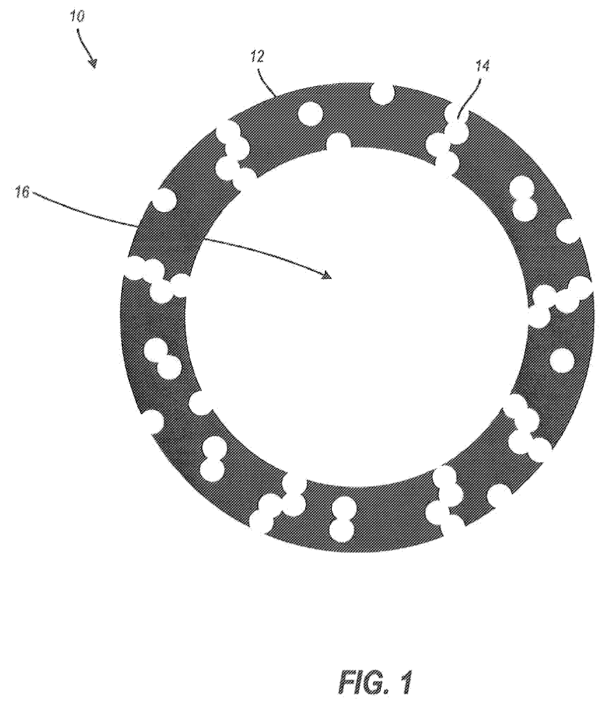

Referring now to FIG. 1, an individual hollow porous microsphere 10 is shown. The individual hollow porous microsphere 10 includes a plurality of pores 14, permitting the entry or exit of hydrogen. The individual hollow porous microsphere 10 includes a hollow area 16 wherein the hydrogen is stored and a wall 12 surrounding the hollow area 16 to contain pressure of hydrogen disposed within the individual hollow porous microsphere 12. The wall 12 is very porous. Each individual hollow porous microsphere 10 acts as a bubble and allows for the free flow of hydrogen between other adjacent bubbles, but without the foaming technologies and all of its inherent deficiencies discussed previously.

Microspheres, or small spherical units, are well-known in the art. For example, in other, unrelated arts, microspheres are used in the biomedical industry for targeted drug delivery, and/or as timed-released capsules. Such microspheres, for example, are manufactured by 3M. Additionally, networks, with sufficient permeation to allow for the flow of hydrogen, with which to create such microspheres, are well known in the chemical industry. Such porous networks are known to be used with flowing gases in fluidized beds and reaction chambers.

Porous microspheres, such as the individual hollow porous microsphere 10 shown here, are hollow and very porous. Porous microspheres are generally made of glass, but they are also manufactured from metals, polymers, composites, and the like, as is well-known in the art. Microspheres are generally inexpensively produced with a high degree of accuracy in wall thickness and diameter and porosity. For example, hollow glass microspheres, also called microballons, are generally manufactured with an approximate diameter from 10 to 300 microns. Such hollow microspheres are used in, for example, syntactic foam as filler, giving it a greater resistance to stress than other foams. This is useful in high-pressure applications wherein traditional foam bubbles would explode.

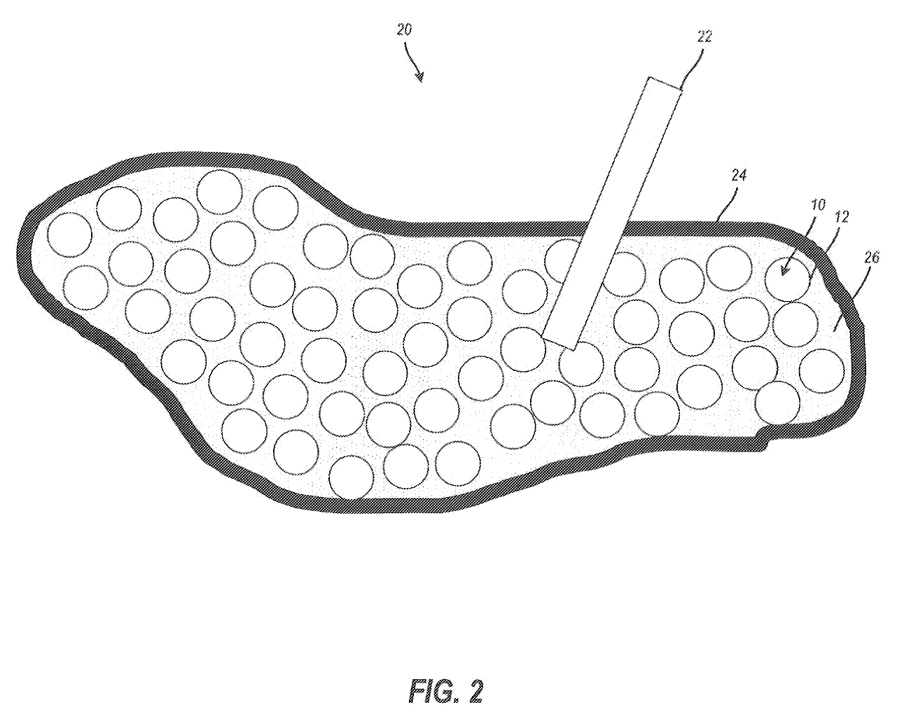

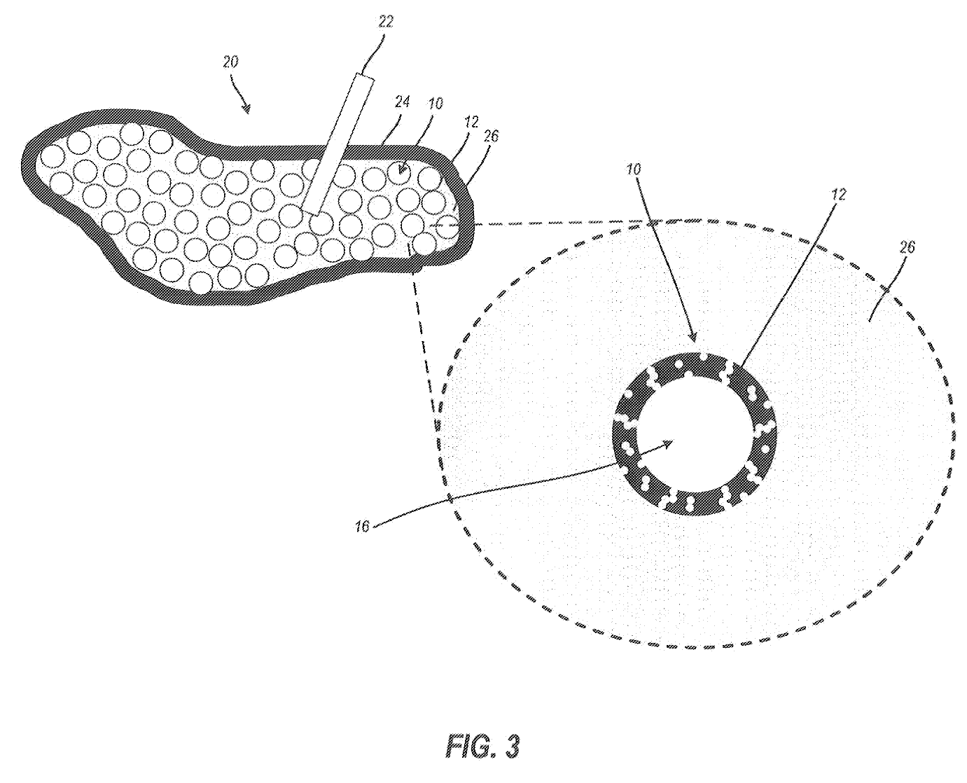

Referring now to FIGS. 2 and 3, a conformable high-pressure hydrogen storage vessel 20 is shown. The conformable high-pressure hydrogen storage vessel 20 is formed by utilizing a plurality of porous microspheres 10. The porous microspheres 10 are generally uniform in diameter, shape, and size, generally porous, and hollow. Utilizing a liquefied, viscous material 26, the liquefied, viscous material and the plurality of microspheres 10 are mixed and poured into a mold. The liquefied, viscous material 26 is a polymer, metal, or the like, so long as the liquefied, viscous material 26 allows for the free flow of hydrogen. The mold is larger in capacity than the mixture of the liquefied, viscous material 26 and the plurality of microspheres 10 and is of a predetermined and desired shape. The mixture poured within the mold is uniformly solidified forming a desired and predetermined shape comprising a conformable high-pressure hydrogen storage vessel 20.

Once the mixture of the liquefied, viscous material 26 and the plurality of microspheres 10 has solidified and subsequently formed the predetermined and desired shape, a coating 24 is applied. The coating 24 is a hydrogen-resistant material. The coating 24 has material characteristics sufficient to bond to the mixture of the liquefied, viscous material 26 and the plurality of microspheres 10 once it has uniformly solidified.

The conformable high-pressure hydrogen storage vessel 20 is equipped with a hydrogen fill line 22. The hydrogen fill line 22 is disposed about conformable high-pressure hydrogen storage vessel 10 and provides a hydrogen fill input path to the conformable high-pressure hydrogen storage vessel 10. Optionally, the conformable high-pressure hydrogen storage vessel 20 is equipped with a plurality of hydrogen fill lines 22 providing a plurality of hydrogen fill input paths to the conformable high-pressure hydrogen storage vessel 10.

In its final form, the conformable high-pressure hydrogen storage vessel 20 is filled with hydrogen through the hydrogen fill line 22, thus inserting hydrogen into each of the plurality of microspheres 10. The pressure of the hydrogen is contained in the hollow area, 16 and within the walls 12, of the plurality of microspheres 10. Hydrogen freely moves about the conformable high-pressure hydrogen storage vessel 20, in a store-and-release manner, with the high pressure being contained by the walls 12 of the each of the plurality of microspheres 10.

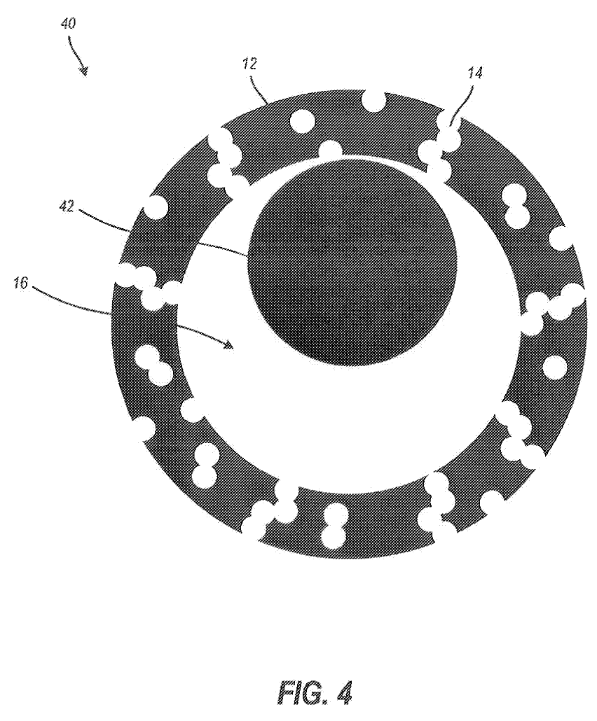

Referring now to FIG. 4, an individual hollow porous microsphere 40, according to an alternative embodiment of the technology, is shown. The individual hollow porous microsphere 40 includes a hollow area 16 wherein the hydrogen is stored and a wall 12 surrounding the hollow area 16 to contain pressure of hydrogen disposed within the individual hollow porous microsphere 12. The wall 12 is very porous. Each individual hollow porous microsphere 40 acts as a bubble and allows for the free flow of hydrogen between, other adjacent bubbles, but without the foaming technologies and all of its inherent deficiencies discussed previously.

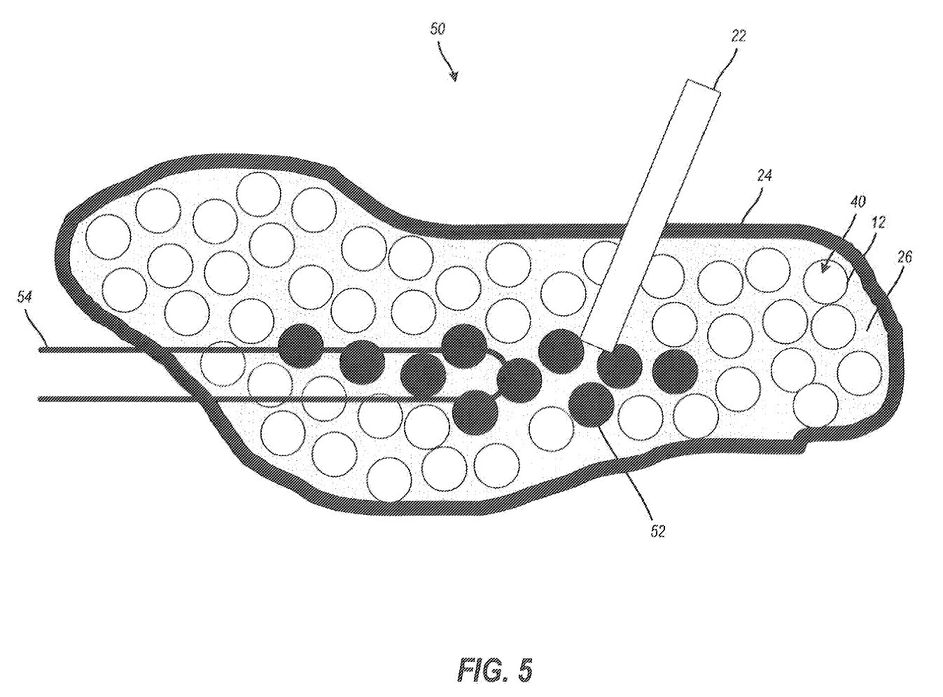

Additionally, however, this individual hollow porous microsphere 40 further includes the encapsulation of a net endothermic (upon gas desorption) material 42 within the individual hollow porous microsphere 40. The net endothermic (upon gas desorption) material 42 is resistant to hydrogen permeation. The net endothermic (upon gas desorption) material is insertable into a hollow area 16 of an individual hollow porous microsphere 40. Thus, once inserted, the net endothermic (upon gas desorption) material is encapsulated within an individual hollow porous microsphere 40, yet freely moves among other individual hollow porous microspheres 40. Alternatively, for example, the microsphere is formed around the storage material. Using such a net endothermic (upon gas desorption) material in an individual hollow porous microsphere 40 provides that the volumetric hydrogen storage density of the conformable high-pressure hydrogen storage vessel (50 in FIG. 5) is increased. The net endothermic (upon gas desorption) material is a metal hydride, adsorbent material, or the like, so long as the net endothermic (upon gas desorption) material 42 is resistant to hydrogen permeation.

Referring now to FIG. 5, a conformable high-pressure hydrogen storage vessel 50, according to yet another alternative embodiment of the technology, is shown. The conformable high-pressure hydrogen storage vessel 50 is formed by utilizing a plurality of porous microspheres 40. The porous microspheres 40 are generally uniform in diameter, shape, and size, generally porous, and hollow. However, a net endothermic (upon gas desorption) material is encapsulated within the porous microspheres 40 in this embodiment.

Utilizing a liquefied, viscous material 26 with a lower melting point than the plurality of microspheres, the liquefied, viscous material 26 and the plurality of microspheres 40 are mixed and poured into a mold. The liquefied, viscous material is a polymer, metal, or the like, so long as the liquefied, viscous material allows for the free flow of hydrogen. The mold is larger in capacity than the mixture of the liquefied, viscous material 26 and the plurality of microspheres 40 and is of a predetermined and desired shape. The mixture poured within the mold is uniformly solidified forming a desired and predetermined shape comprising a conformable high-pressure hydrogen storage vessel 50.

Once the mixture of the liquefied, viscous material 26 and the plurality of microspheres 40 has solidified and subsequently formed the predetermined and desired shape, a coating 24 is applied. The coating 24 is a hydrogen-resistant material. The coating 24 has a lower melting point than the mixture of the liquefied, viscous material 26 and the plurality of microspheres 40. The coating 24 has material characteristics sufficient to bond to the mixture of the liquefied, viscous material 26 and the plurality of microspheres 40 once it has uniformly solidified.

The conformable high-pressure hydrogen storage vessel 50 is equipped with a hydrogen fill line 22. The hydrogen fill line 22 is disposed about conformable high-pressure hydrogen storage vessel 50 and provides a hydrogen fill input path to the conformable high-pressure hydrogen storage vessel 50. Optionally, the conformable high-pressure hydrogen storage vessel 50 is equipped with a plurality of hydrogen fill lines 22 providing a plurality of hydrogen fill input paths to the conformable high-pressure hydrogen storage vessel 50.

The conformable high-pressure hydrogen storage vessel 50 utilizes a heat exchange system 54. The heat exchange system 54 provides a heat input into the conformable high-pressure hydrogen storage vessel 50 to release hydrogen from the net endothermic (upon gas desorption) (upon gas desorption) material. Microspheres containing the net endothermic (upon gas desorption) material 52 are shown in relation to the heat exchange system 54. The heat exchange system 54 further provides cooling to the conformable high-pressure hydrogen storage vessel 50 when the vessel 50 is being filled with hydrogen.

In one embodiment, conformable high-pressure hydrogen storage vessel 50 is utilized in a hydrogen-powered vehicle. As such, the radiator and hydrogen engine within the hydrogen powered vehicle serves as the heat exchange system 54. The hydrogen engine provides the heat input into the conformable high-pressure hydrogen storage vessel 50 to release hydrogen from the net endothermic (upon gas desorption) material encapsulated microspheres 52.

In its final form, the conformable high-pressure hydrogen storage vessel 50 is filled with hydrogen through the hydrogen fill line 22, thus inserting hydrogen into each of the plurality of microspheres 40. The pressure of the hydrogen is contained in the hollow area 16 and within the walls 12, of the plurality of microspheres 40. Hydrogen freely moves about the conformable high-pressure hydrogen storage vessel 50, in a store-and-release manner, with the high pressure being contained by the walls 12 of the each of the plurality of microspheres 40. Microspheres containing the net endothermic (upon gas desorption) material. 52 are accessed by the heat exchange system 54, releasing the hydrogen out of the net endothermic (upon gas desorption) material within the microspheres, thus overcoming any frictional barriers.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A hydrogen storage system for storing hydrogen under pressure, the system comprising:
a conformable high-pressure hydrogen, storage vessel; and
a plurality of microspheres disposed with the conformable high-pressure hydrogen vessel, the microspheres being generally uniform in diameter and size, generally porous, and hollow, and the plurality of microspheres selectively storing and releasing high-pressure hydrogen disposed therein.

2. The hydrogen storage system of claim 1, further comprising:
a liquefied, viscous material wherein the liquefied, viscous material has a lower melting point than the plurality of microspheres and is mixed with the plurality of microspheres; and
wherein the mixture of the liquefied, viscous material and the plurality of microspheres is uniformly solidified to form a desired and predetermined shape.

3. The hydrogen storage system of claim 1 wherein the liquefied, viscous material is a porous network.

4. The hydrogen storage system of claim 1 wherein the liquefied, viscous material is a metal.

5. The hydrogen storage system of claim 2, further comprising:
a mold, the mold being larger in capacity that the mixture of the porous network and the plurality of microspheres, and the mold being in the predetermined, desired shape of a vehicle fuel tank;
wherein the mixture of the liquefied, viscous material and the plurality of microspheres is poured, into the mold; and
wherein the mixture of the liquefied, viscous material and the plurality of microspheres is uniformly solidified to form a conformable high-pressure hydrogen storage vessel in the shape of a vehicle fuel tank.

6. The hydrogen storage system of claim 2, further comprising:
a coating, the coating being comprised of a hydrogen-resistant material, and the coating having a lower melting point than the mixture of the liquefied, viscous material and the plurality of microspheres, and the coating having material characteristics sufficient to bond to the mixture of the liquefied, viscous material and the plurality of microspheres once it has uniformly solidified.

7. The hydrogen storage system of claim 1, wherein the plurality of microspheres further comprise;
a net endothermic (upon gas desorption) material, the net endothermic (upon gas desorption) material being resistant to hydrogen permeation, and the net endothermic (upon gas desorption) material being insertable into a hollow portion of one or more individual microspheres of the plurality of microspheres;
wherein the net endothermic (upon gas desorption) material is encapsulated within one or more individual microsphere of the plurality of microspheres; and
wherein an overall volumetric hydrogen storage density of the conformable high-pressure hydrogen storage vessel is increased.

8. The hydrogen storage system of claim 7, wherein the net endothermic (upon gas desorption) material is a metal hydride.

9. The hydrogen storage system of claim 7, wherein the net endothermic (upon gas desorption) material is an adsorbent material.

10. The hydrogen storage system of claim 7, further comprising:
a heat exchange system, the heat exchange system providing a heat input into the conformable high-pressure hydrogen storage vessel to release hydrogen from the net endothermic (upon gas desorption) material.

11. The hydrogen storage system of claim 10, wherein the heat exchange system further provides cooling to the hydrogen storage system when the hydrogen storage system is being filled with hydrogen.

12. The hydrogen storage system of claim 10, further comprising:
a hydrogen-powered vehicle, the hydrogen powered, vehicle having a radiator, and the heat exchange system comprising the radiator and hydrogen engine; and
wherein the hydrogen engine provides the heat input into the conformable high-pressure hydrogen storage vessel to release hydrogen from the net endothermic (upon gas desorption) material.

13. The hydrogen storage system of claim 1, further comprising:
a hydrogen fill line, the hydrogen fill line being disposed about conformable high-pressure hydrogen storage vessel and providing a hydrogen fill input path to the conformable high-pressure hydrogen storage vessel.

14. The hydrogen storage system of claim 1, further comprising:
a plurality of hydrogen fill lines, the plurality of hydrogen fill lines being disposed about conformable high-pressure hydrogen storage vessel in a plurality of locations, and the plurality of hydrogen fill lines providing a plurality of hydrogen fill input paths to the conformable high-pressure hydrogen storage vessel.

15. The hydrogen storage system of claim 1, further comprising:
a hydrogen-powered vehicle, the hydrogen-powered vehicle being powered by hydrogen stored within an on-board conformable high-pressure hydrogen storage vessel.

16. A hydrogen storage method, for storing hydrogen under pressure, the method comprising:
utilizing a plurality of microspheres, the microspheres being generally uniform in diameter and size, generally porous, and hollow;
utilizing a liquefied, viscous material, wherein the liquefied, viscous material has a lower melting point than the plurality of microspheres;
mixing the plurality of microspheres within the liquefied, viscous material; and
utilizing a mold, the mold being larger in capacity than the mixture of the liquefied, viscous material and the plurality of microspheres, and the mold being in a predetermined, desired shape;
pouring the mixture of the liquefied, viscous material and the plurality of microspheres into the mold; and
uniformly cooling the mixture of the liquefied, viscous material and the plurality of microspheres forming a desired and predetermined shape comprising a conformable high-pressure hydrogen storage vessel.

17. The hydrogen storage method of claim 16, further comprising:
utilizing a coating, the coating being comprised of a hydrogen-resistant material, and the coating having a lower melting point than the mixture of the liquefied, viscous material and the plurality of microspheres, and the coating having material characteristics sufficient to bond to the mixture of the liquefied, viscous material and the plurality of microspheres once it has uniformly solidified; and
applying the coating to the desired and predetermined shape formed by the uniform coding of the mixture of the liquefied, viscous material and the plurality of microspheres.

18. The hydrogen storage method of claim 16, further comprising:
utilizing a net endothermic (upon gas desorption) material, the net endothermic (upon gas desorption) material being resistant to hydrogen permeation, and the net endothermic (upon gas desorption) material being insertable into a hollow portion of one or more individual microspheres of the plurality of microspheres;
inserting the net endothermic (upon gas desorption) material into one or more individual microspheres of the plurality of microspheres; and
wherein an overall volumetric hydrogen storage density of the conformable high-pressure hydrogen storage vessel is increased.

19. The hydrogen storage method of claim 16, further comprising:
utilizing a heat exchange system, the heat exchange system providing a heat input into the conformable high-pressure hydrogen storage vessel to release hydrogen from the net endothermic (upon gas desorption) material;
utilizing a hydrogen-powered vehicle, the hydrogen powered vehicle having a radiator, and the heat exchange system comprising the radiator; and
utilizing one or more hydrogen fill lines, the one or more hydrogen fill lines being disposed about conformable high-pressure hydrogen storage vessel and providing one or more hydrogen fill input paths to the conformable high-pressure hydrogen storage vessel; and
wherein the hydrogen engine provides the heat input into the conformable high-pressure hydrogen storage vessel to release hydrogen from the net endothermic (upon gas desorption) material.

20. The hydrogen storage method of claim 16, wherein the liquefied, viscous material is a porous network.
